(19) United States
(12) Patent Application Publication
(10) Pub. No.: US 2018/0040219 A1
(43) Pub. Date: Feb. 8, 2018

(54) TAG DETECTION USING WAVEFORM RADIATING DEVICES

(71) Applicants: John J. Clark, Boynton Beach, FL (US); James A. Cook, Boynton Beach, FL (US)

(72) Inventors: John J. Clark, Boynton Beach, FL (US); James A. Cook, Boynton Beach, FL (US)

(73) Assignee: Tyco Fire & Security GmbH, Neuhausen Am Rheinfall (CH)

(21) Appl. No.: 15/426,101

(22) Filed: Feb. 7, 2017

Related U.S. Application Data
(60) Provisional application No. 62/371,038, filed on Aug. 4, 2016.

(51) Int. Cl. G08B 13/24

(52) U.S. Cl. CPC G08B 13/246; G08B 13/2428

(57) ABSTRACT

Systems and methods for detecting a security tag. The methods comprise: detecting motion of the security tag while in use to protect an article from unauthorized removal from a protected area; and emitting a first waveform from a radiating device of the security tag in response to the motion's detection. The first waveform is detectable by an Electronic Article Surveillance (“EAS”) monitoring system. The radiating device comprises a device other than an EAS element, a Radio Frequency Identification (“RFID”) device and a Near Field Communication (“NFC”) enabled device.

### CROSS-REFERENCE TO RELATED APPLICATIONS

This application claims priority to U.S. Patent Application No. 62/371,038, filed Aug. 4, 2016. The contents of the above application are incorporated by reference in its entirety.

### FIELD

This document relates generally to security tags used in Electronic Article Surveillance (“EAS”) systems. More particularly, this document relates to security tags and methods for detecting the security tags using waveform radiating devices (e.g., audio speakers and/or piezo components).

### BACKGROUND

A typical EAS system in a retail setting may comprise a monitoring system and at least one security tag or marker attached to an article to be protected from unauthorized removal. The monitoring system establishes a surveillance zone in which the presence of security tags and/or markers can be detected. The surveillance zone is usually established at an access point for the controlled area (e.g., adjacent to a retail store entrance and/or exit). If an article enters the surveillance zone with an active security tag and/or marker, then an alarm may be triggered to indicate possible unauthorized removal thereof from the controlled area. In contrast, if an article is authorized for removal from the controlled area, then the security tag and/or marker thereof can be detached therefrom. Consequently, the article can be carried through the surveillance zone without being detected by the monitoring system and/or without triggering the alarm.

Radio Frequency Identification (“RFID”) systems may also be used in a retail setting for inventory management and related security applications. In an RFID system, a reader transmits a Radio Frequency (“RF”) carrier signal to an RFID device. The RFID device responds to the carrier signal with a data signal encoded with information stored by the RFID device. Increasingly, passive RFID labels are used in combination with EAS labels in retail applications.

As is known in the art, security tags for security and/or inventory systems can be constructed in any number of configurations. The desired configuration of the security tag is often dictated by the nature of the article to be protected. For example, EAS and/or RFID labels may be enclosed in a rigid tag housing, which can be secured to the monitored object (e.g., a piece of clothing in a retail store). The rigid housing typically includes a removable pin which is inserted through the fabric and secured in place on the opposite side by a mechanism disposed within the rigid housing. The housing cannot be removed from the clothing without destroying the housing except by using a dedicated removal device.

A typical retail sales transaction occurs at a fixed Point Of Sale (“POS”) station manned by a store sales associate. The store sales associate assists a customer with the checkout process by receiving payment for an item. If the item is associated with an EAS/RFID element, the store sales associate uses the dedicated removal device to remove the security tag from the purchased item.

A retail sales transaction can alternatively be performed using a mobile POS unit. In this case, the security tag may be removed from the purchased item via: the use of a mobile detacher unit in addition to a mobile POS unit; the use of a fixed detacher unit located within the retail store which reduces the mobility of the mobile POS unit; or the use of a fixed detacher unit located at an exit of a retail store.

### SUMMARY

This document concerns systems and methods for detecting a security tag. The security tag: may comprise an EAS element that is inoperative; or may be absent of an operative EAS element. As such, the methods provide a way for an EAS monitoring system to detect the EAS security tag other than through the use of the EAS element. In this regard, the methods comprise: detecting motion of the security tag while in use to protect an article from unauthorized removal from a protected area; and emitting a first waveform from a radiating device of the security tag in response to the motion's detection. The first waveform detectable by an EAS monitoring system. The radiating device comprises a device other than an EAS element, a Radio Frequency Identification (“RFID”) device and a Near Field Communication (“NFC”) enabled device. For example, the radiating device comprises an audio speaker, a piezo, an antenna, magnetic loop, or metallic housing.

In some scenarios, the methods further comprise: performing operations by the security tag to determine if the security tag is still coupled to the article despite having authorization for the security tag's decoupling from the article; selecting a second waveform from a plurality of waveforms when a determination is made that the security tag is still coupled to the article despite having the authorization; and emitting the second waveform from the radiating device. The second waveform is different from the first waveform, indicates that the security tag is still coupled to the article, and is detectable by the EAS monitoring system.

In those or other scenarios, the methods further comprise: performing operations by the security tag to select a third waveform from a plurality of waveforms based on a characteristic (e.g., priority, price, color, size, department, and/or manufacturer) of the article relative to that of other articles; and emitting the third waveform from the radiating device. The third waveform is different from the first waveform and detectable by the EAS monitoring system.

In those or other scenarios, the methods further comprise: determining if the security tag is being removed from a protected area without authorization (e.g., while being coupled to the article without the article being successfully purchased or while being decoupled from a successfully purchased article); selecting a fourth waveform from a plurality of waveforms when a determination is made that the security tag is still coupled to the article despite having the authorization; and emitting the fourth waveform from the radiating device. The fourth waveform is different from the first waveform, indicates that the security tag is still coupled to the article, and is detectable by the EAS monitoring system.

The radiation element discontinues emitting the first, second, third or fourth waveform when the motion of security tag is no longer detected, a pre-specified period of time has expired, authorization has been obtained to decouple security tag from the article or remove the article from the protected area, and/or the security tag has been decoupled from the article with proper authorization.

### DESCRIPTION OF THE DRAWINGS

Embodiments will be described with reference to the following drawing figures, in which like numerals represent like items throughout the figures.

FIG. 1 is a schematic illustration of an exemplary system.

FIG. 2 is a block diagram of an exemplary architecture for a security tag shown in FIG. 1.

FIGS. 3A-3B (collectively referred to herein as “FIG. 3”) provide a flow diagram of an exemplary method for detecting the security tags using waveform radiating devices (e.g., audio speakers and/or piezo components).

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Smart security tags are being developed to enable customer removability based on the payment using an MPOS unit. The smart security tags include additional electronics and clasping mechanisms. These electronics and clasping mechanisms can interfere with the tags' acousto-magnetic components being utilized for EAS purposes. This interference can cause tag detection failures by the EAS system, i.e., active smart security tags may not be detected when present in the surveillance zone. In the case where magnets are used to attach the clasping mechanism to items-to-be-protected, the security tags may be rendered ineffective or inoperable.

Accordingly, the present solution addresses this issue by providing an alternative technique to issue an alarm by an EAS system if a smart security tag does not have an EAS component or has an inoperative EAS component. The alternative technique involves emitting a waveform from the smart security tag using a radiating device other than an EAS component, a Radio Frequency Identification (“RFID”) component, and/or Near Field Communication (“NFC”) component. The waveform is emitted when a detection is made that the smart security tag is in motion, the smart security tag has not been decoupled from an article despite having authorization, and/or the smart security tag is being removed from a protected area without authorization while still being coupled to the article.

In some scenarios, the present solution uses audio speakers or other radiating devices (e.g., a piezo component) of the smart security tags to emit the waveform. These audio speakers or other radiating devices of the smart security tags are used to emit waveforms having a given pattern or frequency (e.g., 58 kHz). The frequency is selected to be within a range that is not audible to humans and that is detectable by an EAS system. The EAS system will issue an alarm upon its detection of the waveforms with the given pattern or frequency. In some cases, unique tag waveforms may be employed (e.g., to indicate a tag state and/or distinguish the tags from jamming devices).

The waveforms are emitted from the smart security tags based on the occurrence of a trigger event. For example, a smart security tag (that is not authorized to be decoupled from an item and/or removed from a protected area) starts to emit the waveform from the audio speaker or other radiating device in response to a sensor's (e.g., an accelerometers) detection of tag motion and/or an expiration of a period of time from said detection. The smart security tag stops emitting the waveform in response to or shortly after the sensor stops detecting movement thereof. Once the smart security tag has been authorized for detachment from the item or removal from a protected area, the waveform would either not start or would stop or emit a different waveform based on the status of the smart tag until the tag is reactivated.

Exemplary Systems for Tag Detection using Radiating Devices

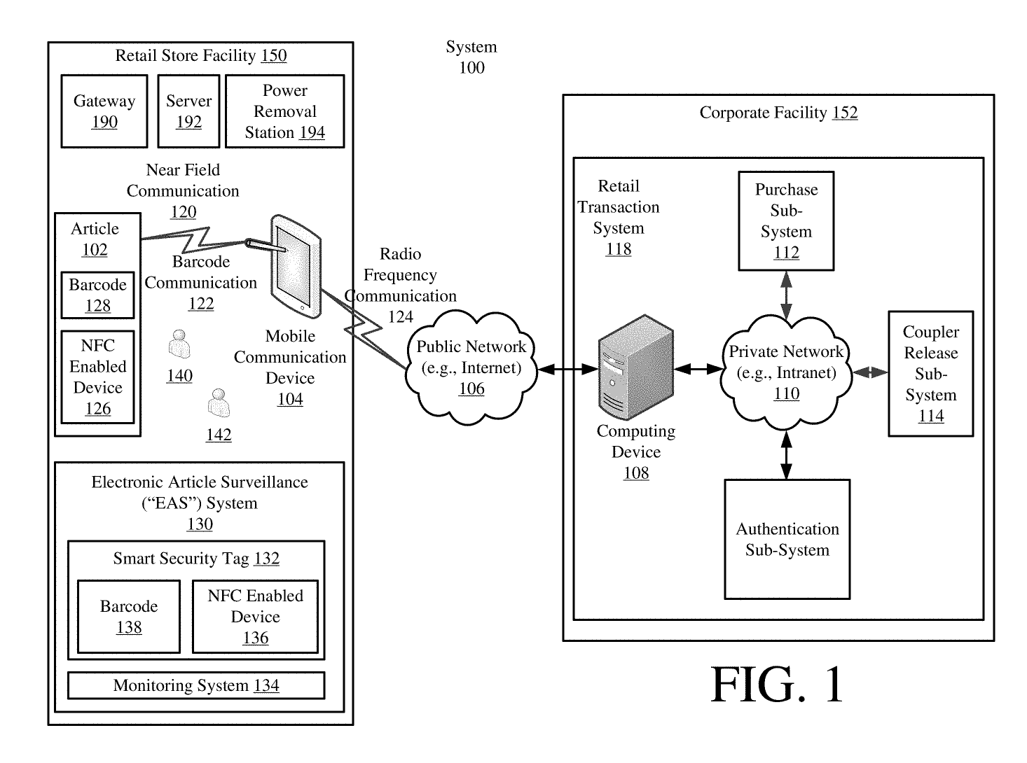

Referring now to FIG. 1, there is provided a schematic illustration of an exemplary system 100. System 100 comprises a Retail Store Facility (“RSF”) 150 including an EAS system 130. The EAS system 130 comprises a monitoring system 134 and at least one smart security tag 132. Although not shown in FIG. 1, the smart security tag 132 is attached to article 102, thereby protecting the article 102 from an unauthorized removal from the RSF 150. The monitoring system 134 establishes a surveillance zone (not shown) within which the presence of the smart security tag 132 can be detected via a primary tag detection process (e.g., via use of a Non-Deactivable Sheet Label (“NDL”)) and via a secondary tag detection process (e.g., via use of a radiating element other than an NDL). The primary tag detection process includes any known conventional EAS tag detection process. The second tag detection process is facilitated via implementation of the present solution. The surveillance zone is established at an access point (not shown) for the RSF 150. If the smart security tag 132 is carried into the surveillance zone, then an alarm is triggered to indicate (1) the continued tag-article coupling despite having authorization to be decoupled from each other or (2) a possible unauthorized removal of the article 102 from the RSF 150.

In some cases, the smart security tag 132 may not comprise an EAS component facilitating the primary tag detection process or may have an EAS component that is inoperable. As such, the monitoring system 134 is unable to detect the smart security tag 132 when present within the surveillance zone via the primary tag detection process. The present solution provides a means to address this issue via implementation of the secondary tag detection process. The secondary tag detection process will be discussed in detail below. However, prior to discussing the present solution, other operations of system 100 should be understood.

During store hours, a customer 140 may desire to purchase the article 102. The customer 140 can purchase the article 102 without using a traditional fixed POS station (e.g., a checkout counter). Instead, the purchase transaction can be achieved using a Mobile Communication Device (“MCD”) 104. MCD 104 (e.g., a mobile phone or tablet computer) can be in the possession of the customer 140 or store associate 142 at the time of the purchase transaction. Notably, MCD 104 has a retail transaction application installed thereon that is configured to facilitate the purchase of article 102 and/or an attachment/detachment of the smart security tag 132 to/from article 102. The retail transaction application can be a pre-installed application, an add-on application or a plug-in application.

In order to initiate a purchase transaction, the retail transaction application is launched via a user-software interaction. The retail transaction application facilitates the exchange of data between the article 102, smart security tag 132, customer 140, store associate 142, and/or Retail Transaction System (“RTS”) 118. For example, after the retail transaction application is launched, a user 140, 142 is prompted to start a retail transaction process for purchasing the article 102. The retail transaction process can be started simply by performing a user software interaction, such as depressing a key on a keypad of the MCD 104 or touching a button on a touch screen display of the MCD 104.

Subsequently, the user 140, 142 may manually input into the retail transaction application article information. Alternatively or additionally, the user 140, 142 places the MCD 104 in proximity of article 102. As a result of this placement, the MCD 104 obtains article information from the article 102. The article information includes any information that is useful for purchasing the article 102, such as an article identifier and an article purchase price. In some scenarios, the article information may even include an identifier of the smart security tag 132 attached thereto. The article information can be communicated from the article 102 to the MCD 104 via a Short Range Communication (“SRC”), such as a barcode communication 122 or an NFC 120. In the barcode scenario, article 102 has a barcode 128 attached to an exposed surface thereof. In the NFC scenarios, article 102 may comprise an NFC enabled device 126.

Thereafter, payment information is input into the retail transaction application of MCD 104 by the user 140, 142. Upon obtaining the payment information, the MCD 104 automatically performs operations for establishing a retail transaction session with the RTS 118. The retail transaction session can involve: communicating the article information and payment information from MCD 104 to the RTS 118 via an RF communication 124 and public network 106 (e.g., the Internet); completing a purchase transaction by the RTS 118; and communicating a response message from the RTS 118 to MCD 104 indicating that the article 102 has been successfully or unsuccessfully purchased. The purchase transaction can involve using an authorized payment system, such as a bank Automatic Clearing House (“ACH”) payment system, a credit/debit card authorization system, or a third party system (e.g., PayPal®, SolidTrust Pay® or ApplePay®).

The purchase transaction can be completed by the RTS 118 using the article information and payment information. In this regard, such information may be received by a computing device 108 of the RTS 118 and forwarded thereby to a sub-system of a private network 110 (e.g., an Intranet). For example, the article information and purchase information can also be forwarded to and processed by a purchase sub-system 112 to complete a purchase transaction. When the purchase transaction is completed, a message is generated and sent to the MCD 104 indicating whether the article 102 has been successfully or unsuccessfully purchased.

If the article 102 has been successfully purchased, then a security tag detaching process can be started automatically by the RTS 118, the MCD 104 and/or the PRS 194. Alternatively, the user 140, 142 can start the security tag detaching process by performing a user-software interaction using the MCD 104 and/or the PRS 194. In all three scenarios, the article information can optionally be forwarded to and processed by a coupler release sub-system 114 to retrieve a detachment key, a detachment code and/or a purchase token that is useful for detaching the smart security tag 132 from the article 102. The detachment key/code and/or purchase token is(are) then sent from the RTS 118 to the PRS 194 such that the PRS 194 can perform or cause the same to perform tag detachment operations. The tag detachment operations are generally configured to cause actuation of a detaching mechanism (not shown in FIG. 1). In this regard, the PRS 194 supplies power to the smart security tag 132. The PRS 194 may also generate a detach command and sends a wireless detach signal including the detach command to the security tag 132. In this case, the smart security tag 132 authenticates the detach command and activates the detaching mechanism (e.g., by actuating a switch so that power is able to be supplied thereto). For example, the detach command causes a pin to be retracted or a clamp/clasp to be opened such that the security tag can be removed from the article 102. Once the smart security tag 132 has been removed from article 102, the customer 140 can carry the article 102 through the surveillance zone without setting off the alarm.

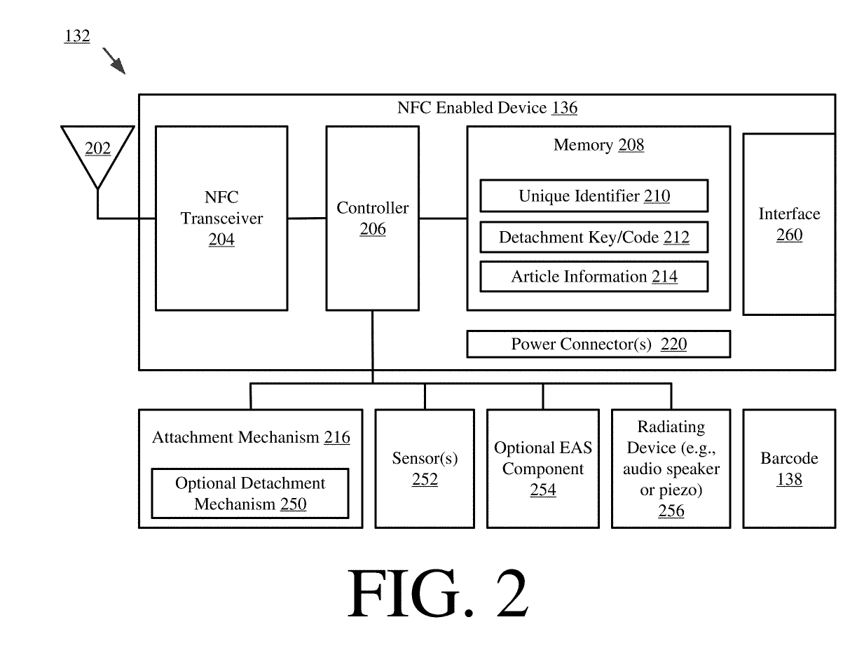

Referring now to FIG. 2, there is provided a schematic illustration of an exemplary architecture for the smart security tag 132. Smart security tag 132 can include more or less components than that shown in FIG. 2. However, the components shown are sufficient to disclose an illustrative embodiment implementing the present solution. Some or all of the components of the smart security tag 132 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 2 represents an exemplary representative smart security tag 132 configured to facilitate the prevention of an unauthorized removal of an article (e.g., article 102 of FIG. 1) from an RSF (e.g., RSF 150 of FIG. 1) even when there is no EAS component or there is an inoperative EAS component 254. In this regard, the smart security tag 132 may have a barcode 138 affixed thereto for allowing data to be exchanged with an external device (e.g., MCD 104 of FIG. 1) via barcode technology.

The smart security tag 132 also comprises an antenna 202 and an NFC enabled device 136 for allowing data to be exchanged with the external device via NFC technology. The antenna 202 is configured to receive NFC signals from the external device and transmit NFC signals generated by the NFC enabled device 136. The NFC enabled device 136 comprises an NFC transceiver 204. NFC transceivers are well known in the art, and therefore will not be described herein. However, it should be understood that the NFC transceiver 204 processes received NFC signals to extract information therein. This information can include, but is not limited to, a request for certain information (e.g., a unique identifier 210), and/or a message including information specifying a detachment key or code 212 for detaching the security tag 132 from an article. The NFC transceiver 204 may pass the extracted information to the controller 206.

If the extracted information includes a request for certain information, then the controller 206 may perform operations to retrieve a unique identifier 210 and/or article information 214 from memory 208. The article information 214 can include a unique identifier of an article and/or a purchase price of the article. The retrieved information is then sent from the smart security tag 132 to a requesting external device (e.g., MCD 104 of FIG. 1) via an NFC communication.

In contrast, if the extracted information includes information specifying a one-time-only use key and/or instructions for programming the smart security tag 132 to actuate an optional detachment mechanism 250 of an attachment mechanism 216, then the controller 206 may perform operations to simply actuate the detachment mechanism 250 using the one-time-only key. Alternatively or additionally, the controller 206 can: parse the information from a received message; retrieve a detachment key/code 212 from memory 208; and compare the parsed information to the detachment key/code to determine if a match exists therebetween. If a match exists, then the controller 206 generates and sends a command to the attachment mechanism 216 for actuating the detachment mechanism 250. An auditory or visual indication can be output by the smart security tag 132 when the detachment mechanism 250 is actuated. If a match does not exist, then the controller 206 may generate a response message indicating that detachment key/code specified in the extracted information does not match the detachment key/code 212 stored in memory 208. The response message may then be sent from the smart security tag 132 to a requesting external device (e.g., MCD 104 of FIG. 1) via a wireless short-range communication or a wired communication via interface 260. A message may also be communicated to another external device or network node via interface 260.

In some scenarios, the connections between components 204, 206, 208, 216, 260 are unsecure connections or secure connections. The phrase “unsecure connection”, as used herein, refers to a connection in which cryptography and/or tamper-proof measures are not employed. The phrase “secure connection”, as used herein, refers to a connection in which cryptography and/or tamper-proof measures are employed. Such tamper-proof measures include enclosing the physical electrical link between two components in a tamper-proof enclosure.

Notably, the memory 208 may be a volatile memory and/or a non-volatile memory. For example, the memory 208 can include, but is not limited to, a Random Access Memory (“RAM”), a Dynamic Random Access Memory (“DRAM”), a Static Random Access Memory (“SRAM”), a Read-Only Memory (“ROM”) and a flash memory. The memory 208 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

The attachment mechanism 216 is generally configured to securely couple or attach the smart security tag 132 to an article. In this regard, the attachment mechanism 216 includes, but is not limited to, a pin, a lanyard, a plunger, a plastic strap, a clamp or a clasp. In the pin scenarios, the pin can be secured within a housing of the smart security tag 132 via a magnetic clamp or clasp. Such attachment mechanisms are well known in the art, and will not be described in detail herein. A security tag with an exemplary pin/magnetic clamp arrangement is described in U.S. Pat. No. 8,8477,762 to Ming-Ren et al. In some scenarios, the smart security tag is similar to that described in this patent with additional electronic and/or mechanical components.

As noted above, the smart security tag may comprises an optional detachment mechanism 250. The attachment mechanism 216 is operable to control operations of the detachment mechanism 250. The detachment mechanism 250 can include at least one permanent magnet configured to be moved into and out of alignment with the magnetic clamp and/or an electromagnetic configured to be turned “On” via the application of power thereto and “Off” via the termination of the applied power.

The attachment mechanism 216 is shown in FIG. 2 as being indirectly coupled to NFC transceiver 204 via controller 206. The invention is not limited in this regard. The electro-mechanical attachment mechanism 216 can additionally or alternatively be directly coupled to the NFC transceiver 204. One or more of the components 204, 206 can cause the magnet of the detachment mechanism 250 to be transitioned between aligned/unaligned positions and/or On/Off states in accordance with information received from an external device (e.g., PRS 194 of FIG. 1). The components 204-208, 260 may be collectively referred to herein as the NFC enabled device 136.

The NFC enabled device 136 can be incorporated into a device which also houses the attachment mechanism 216, or can be a separate device which is in direct or indirect communication with the attachment mechanism 216. Notably, the NFC enabled device 136 may or may not be coupled to an internal power source. In the later scenario, an external power source is provided by the PRS 194 of FIG. 1. In this regard, NFC enabled device 136 comprises a power connector(s) 220. Alternatively or additionally, the NFC enabled device 136 is configured as a passive device which derives power from an RF signal inductively coupled thereto.

As shown in FIG. 2, the smart security tag 132 may comprise an optional EAS component 254 (e.g., an NDL). An EAS interrogation signal is transmitted at the entrance and/or exit of the retail store by the EAS system 130 of FIG. 1. The EAS interrogation signal causes the EAS component 254 to produce a detectable response if an attempt is made to remove the article without first detaching the security tag therefrom. The EAS component 254 may include, but is not limited to, an acousto-magnetic element.

In some scenarios, the EAS component 254 is rendered inoperable during use of the smart security tag such that it does not produce the detectable response to the interrogation signal. Accordingly, the present solution provides an alternative way to allow the EAS system to detect the smart security tag 132 in this situation despite the fact that the EAS component 254 has been rendered inoperable.

In this regard, the smart security tag 132 comprises a radiating device 256. The radiating device 256 includes, but is not limited to, an audio speaker and/or a piezo element. The radiating device 256 emits a waveform having a select frequency (e.g., 58 kHz) or pattern when (1) the tag is still coupled to the article despite having decoupling authorization (e.g., the item has been successfully purchased), (2) the tag is being removed from the RSF while still attached to the item that is not authorized to leave the RSF, (3) a sensor 252 (e.g., an accelerometer) detects tag motion, and/or (4) a predetermined period of time expires. In some scenarios, the frequency is selected to fall within a range of sound frequencies that are not detectable by humans (e.g., >20 kHz). The waveform is detectable by the EAS system 130 of FIG. 1 such that the alarm is issued to indicate (1) a continued tag-article coupling despite having authorization for the decoupling thereof or (2) a possible unauthorized removal of the article 102 from the RSF 150 (even when the tag does not have an EAS component 254 or has an inoperable EAS component). The waveform may be a unique waveform assigned to the smart security tag 132. The signature of the waveform may indicate a tag state and/or distinguish the smart security tag 132 from jamming devices.

In some scenarios, the smart security tag 132 is a smart alarming tag employing an audio speaker to emit a loud alarming sound if the tag has been detached from the article without authorization (e.g., the item has not been successfully purchased). This same audio speaker can be used to emit the waveform detectable by the EAS system 130 of FIG. 1. Techniques for determining if a tag has been decoupled from an article without authorization are well known in the art, and therefore will not be described in detail herein. Any known or to be known technique for making this determination can be used herein without limitation.

The smart security tag architecture is not limited to that shown in FIG. 2. For example, the smart security tag 132 may additionally comprise an RFID component and/or a power harvesting circuit (e.g., photovoltaic cells and a super capacitor). RFID components and power harvesting circuits are well known in the art, and therefore will not be described herein. These optional components are not shown in FIG. 2 simply for drawings simplicity reasons.

Exemplary Methods for Tag Detection using an Audio Speaker

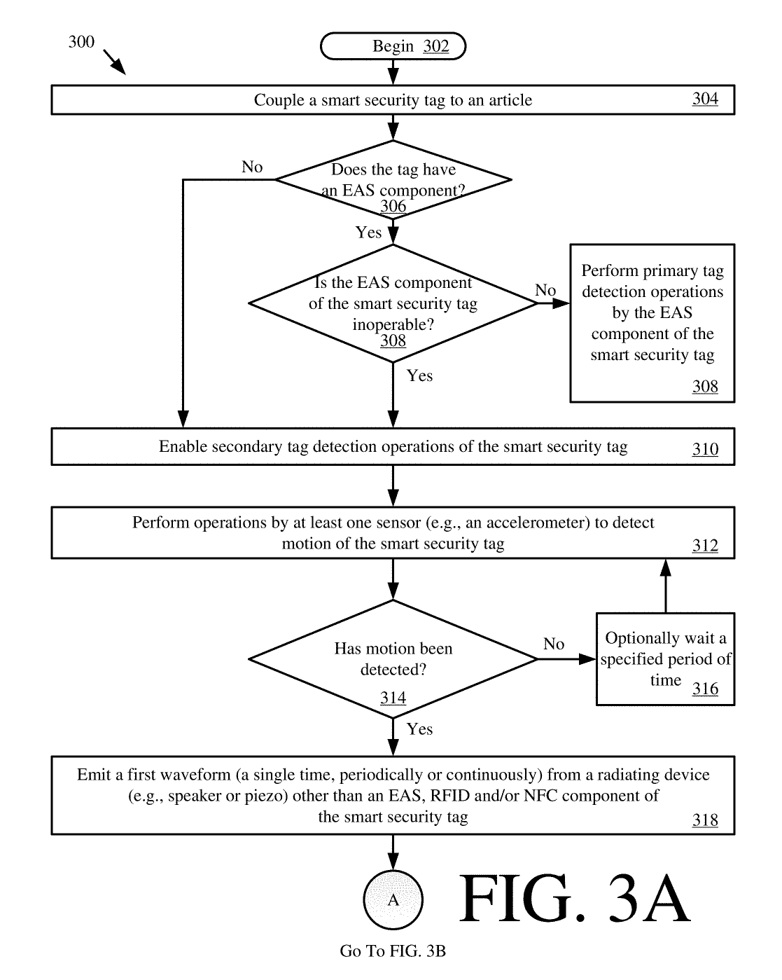

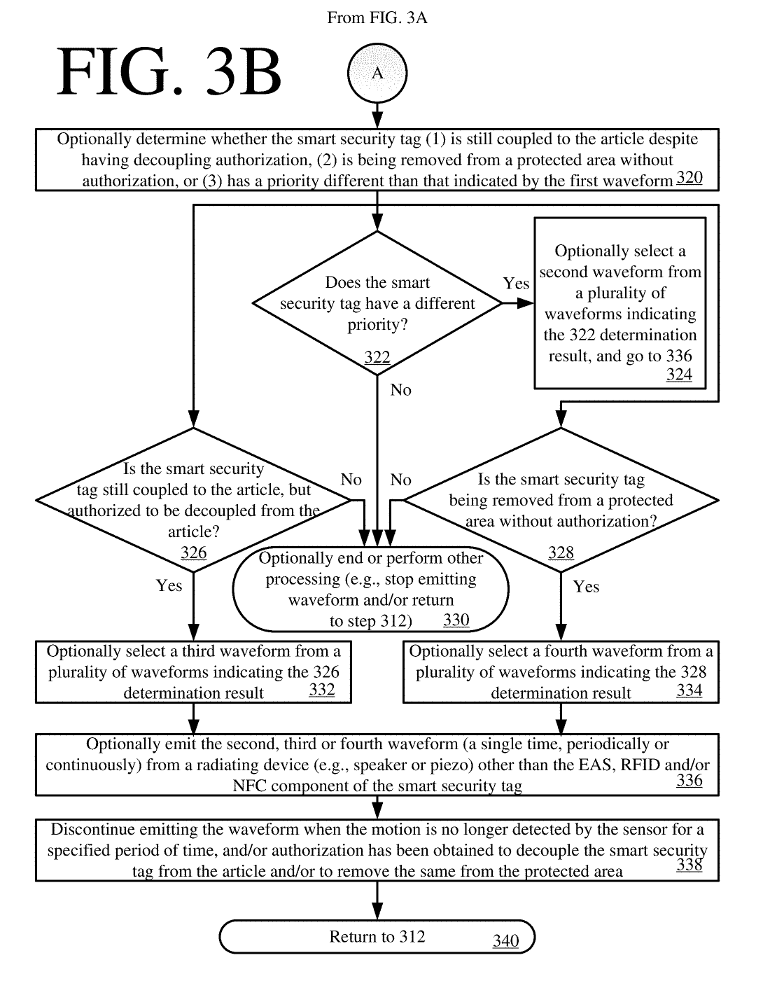

Referring now to FIG. 3, there is provided a flow diagram of an exemplary method 300 for detecting the security tags using waveform radiating devices (e.g., audio speakers and/or piezo components). Method 300 begins with 302 and continues to 304 where a smart security tag (e.g., smart security tag 132 of FIGS. 1-2) is coupled to an article (e.g., article 102 of FIG. 1). The smart security tag may or may not comprise an EAS component (e.g., optional EAS component 254 of FIG. 2). In the event that the smart security tag has an EAS component [306:YES], operations are performed to determine if the EAS component is inoperable. These operations can be performed using a transceiver and/or coil placed adjacent to the EAS component. The transceiver and/or coil may be disposed internal or external to the smart security tag's housing. If the EAS component is operative [308:NO], then primary tag detection operations are performed using the EAS component. The primary tag detection operations include, but are not limited to, known conventional EAS tag detection operations. These known conventional EAS tag detection operations will not be discussed herein.

In the event the smart security tag does not have an EAS component [306:NO] or has an inoperable EAS component [308:YES], 310 is performed where secondary tag detection operations of the smart security tag are enabled. The secondary tag detection operations are now described in relation to 312-340 of FIG. 3. In 312, at least one sensor (e.g., sensor(s) 252 of FIG. 2) performs operations to detect motion of the smart security tag. If motion is not detected [314:NO], then method 300 optionally waits a period of time as shown by 316 and/or returns to 312. In contrast, if motion is detected [314:YES], then a first waveform is emitted from a radiating device (e.g., radiating device 256 of FIG. 2) of the smart security tag. The first waveform is emitted once, periodically or continuously from the radiating device. The radiating device is a device other than an EAS component (e.g., optional EAS component 254 of FIG. 2), an RFID component and/or an NFC component (e.g., NFC enabled device 136 of FIGS. 1-2) of the smart security tag. Upon completing 318, method 300 continues with optional 320 of FIG. 3B.

As shown in FIG. 3B, 320 involves optionally determining if the smart security tag (1) is still coupled to the article despite having decoupling authorization, (2) is being removed from a protected area (e.g., RSF 150 of FIG. 1) without authorization, or (3) has a priority different than that indicated by the first waveform. The first determination (1) can be made by the security tag based on information stored in the security tag's memory (e.g., memory 208 of FIG. 2) (such as a recently received authorization confirmation code or detachment code) and a current state of an attachment mechanism (e.g., attachment mechanism 216 of FIG. 1). The second determination (2) can be made by the security tag based on sensor information (e.g., if tag motion is still being detected after expiration of a given period of time (e.g., the time it takes to make a successful purchase) than a determination is made that the tag is being removed from the protected area without authorization). The third determination (3) can be made based on article information stored in the tag's memory (e.g., a cost of the article and/or a relative priority of the article). If the answer to one or more of these questions are no [322:NO; 326:NO; 328;NO], then method 300 ends or other processing is performed as shown by 330. The other processing can include, but is not limited to, stop emitting the waveform and/or return to 312.

In contrast, if the smart security tag has a priority different than that indicated by the first waveform [322:YES], then a second waveform is selected from a plurality of waveforms indicating the results of the determination made in 322, as shown by 324. If the smart security tag is still coupled to the article despite having decoupling authorization [326:YES], then a third waveform is selected from the plurality of waveforms indicating the results of the determination made in 326, as shown by 332. If the smart security tag is being removed from the protected area without authorization (e.g., while being coupled to the article without the article being successfully purchased or while being decoupled from a successfully purchased article) [328:YES], then a fourth waveform is selected from the plurality of waveforms indicating the results of the determination made in 328, as shown by 334.

Subsequent to selecting the second, third or fourth waveform, 336 is performed. In 336, the selected second, third or fourth waveform is emitted from the radiating device of the smart security tag. The waveform is emitted once, periodically or continuously. The radiating device discontinues emitting the first, second, third or fourth waveform in 338 when the motion is no longer detected by the sensor, a specified period of time has expired, and/or authorization has been obtained to decouple the smart security tag from the article and/or to remove the same from the protected area. Thereafter, 340 is performed where method 300 returns to 312. By returning to 312, the smart security tag is prevented from being stolen after it was decoupled from an article with authorization.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for detecting a security tag, comprising:
detecting motion of the security tag while in use to protect an article from unauthorized removal from a protected area; and
emitting a first waveform from a radiating device of the security tag in response to the motion's detection, the first waveform detectable by an Electronic Article Surveillance (“EAS”) monitoring system;
wherein the radiating device comprises a device other than an EAS element, a Radio Frequency Identification (“RFID”) device and a Near Field Communication (“NFC”) enabled device.

2. The method according to claim 1, wherein the radiating device comprises an audio speaker, a piezo, an antenna, a magnetic loop, or a metallic housing.

3. The method according to claim 1, wherein the EAS element is disposed within the security tag.

4. The method according to claim 3, wherein the EAS element is inoperative.

5. The method according to claim 1, wherein the security tag is exclusive of the EAS element.

6. The method according to claim 1, further comprising:
performing operations by the security tag to determine if the security tag is still coupled to the article despite having authorization for the security tag's decoupling from the article;
selecting a second waveform from a plurality of waveforms when a determination is made that the security tag is still coupled to the article despite having the authorization, the second waveform (a) being different from the first waveform, (b) indicating that the security tag is still coupled to the article and (c) being detectable by the EAS monitoring system; and
emitting the second waveform from the radiating device.

7. The method according to claim 1, further comprising:
performing operations by the security tag to select a third waveform from a plurality of waveforms based on a characteristic of the article relative to that of other articles, the third waveform being (a) different from the first waveform and (b) detectable by the EAS monitoring system; and
emitting the third waveform from the radiating device.

8. The method according to claim 1, further comprising:
determining if the security tag is being removed from a protected area without authorization;
selecting a fourth waveform from a plurality of waveforms when a determination is made that the security tag is still coupled to the article despite having the authorization, the second waveform (a) being different from the first waveform, (b) indicating that the security tag is still coupled to the article and (c) being detectable by the EAS monitoring system; and
emitting the fourth waveform from the radiating device.

9. The method according to claim 1, further comprising discontinuing emitting the first waveform when the motion of security tag is no longer detected.

10. The method according to claim 1, further comprising discontinuing emitting the first waveform when authorization has been obtained to decouple security tag from the article or remove the article from the protected area.

11. A security tag, comprising:
a sensor configured to detect motion of the security tag while in use to protect an article from unauthorized removal from a protected area; and
a radiating device configured to emit a first waveform in response to the motion's detection, the first waveform detectable by an Electronic Article Surveillance (“EAS”) monitoring system;
wherein the radiating device comprises a device other than an EAS element, a Radio Frequency Identification (“RFID”) device and a Near Field Communication (“NFC”) enabled device.

12. The security tag according to claim 11, wherein the radiating device comprises an audio speaker, a piezo, an antenna, a magnetic loop, or a metallic housing.

13. The security tag according to claim 11, wherein the EAS element is disposed within the security tag.

14. The security tag according to claim 13, wherein the EAS element is inoperative.

15. The security tag according to claim 11, wherein the security tag is exclusive of the EAS element.

16. The security tag according to claim 11, wherein the security tag further comprises:
a processing device configured to:
determine if the security tag is still coupled to the article despite having authorization for the security tag's decoupling from the article;
select a second waveform from a plurality of waveforms when a determination is made that the security tag is still coupled to the article despite having the authorization, the second waveform (a) being different from the first waveform, (b) indicating that the security tag is still coupled to the article and (c) being detectable by the EAS monitoring system; and
wherein the radiating device emits the second waveform.

17. The security tag according to claim 11, wherein the security tag further comprises:
a processing device configured to select a third waveform from a plurality of waveforms based on a characteristic of the article relative to that of other articles, the third waveform being (a) different from the first waveform and (b) detectable by the EAS monitoring system; and
wherein the radiating device emits the third waveform.

18. The security tag according to claim 11, wherein the security tag further comprises:
a processing device configured to
determine if the security tag is being removed from a protected area without authorization;
select a fourth waveform from a plurality of waveforms when a determination is made that the security tag is still coupled to the article despite having the authorization, the second waveform (a) being different from the first waveform, (b) indicating that the security tag is still coupled to the article and (c) being detectable by the EAS monitoring system; and
wherein the radiating device emits the fourth waveform.

19. The security tag according to claim 11, wherein the radiating element discontinues emitting the first waveform when the motion of security tag is no longer detected.

20. The security tag according to claim 11, wherein the radiating element discontinues emitting the first waveform when authorization has been obtained to decouple security tag from the article or remove the article from the protected area.
